(19) United States
(12) Patent Application Publication
(10) Pub. No.: US 2016/0124330 A1
(43) Pub. Date: May 5, 2016

(54) ELECTROPHOTOGRAPHIC PHOTOSENSITIVE MEMBER, METHOD FOR MANUFACTURING THE SAME, PROCESS CARTRIDGE, AND ELECTROPHOTOGRAPHIC APPARATUS

(71) Applicant: CANON KABUSHIKI KAISHA, Ohta-ku, Tokyo (JP)

(72) Inventors: Kan TANABE, Toride-shi (JP); Yuka ISHIDUKA, Suntou-gun (JP); Ryoichi TOKIMITSU, Kashiwa-shi (JP); Wataru KITAMURA, Abiko-shi (JP); Mai MURAKAMI, Kashiwa-shi (JP)

(21) Appl. No.: 14/787,456

(22) PCT Filed: Mar. 28, 2014
(86) PCT No.: PCT/JP2014/059914

§ 371 Date: Oct. 27, 2015

(30) Foreign Application Priority Data
Apr. 30, 2013 (JP) 2013-096013

(51) Int. Cl. G03G 15/00

(52) U.S. Cl. CPC G03G 5/144

(57) ABSTRACT

The present invention provides an electrophotographic photosensitive member which includes a support, an undercoat layer formed on the support, a photosensitive layer formed on the undercoat layer, and the undercoat layer contains metal oxide particles and a compound represented by the formula (1).

### TECHNICAL FIELD

The present invention relates to an electrophotographic photosensitive member, a method for manufacturing the same, a process cartridge, and an electrophotographic apparatus.

### BACKGROUND ART

As an electrophotographic photosensitive member used for an electrophotographic apparatus, there has been used an electrophotographic photosensitive member including an undercoat layer formed on a support and a photosensitive layer which is formed on the undercoat layer and which contains a charge generation substance and a charge transport substance. The undercoat layer has a function to improve the adhesion between the support and the photosensitive layer and a function to suppress charge injection from a support side to a photosensitive layer side.

In recent years, for the electrophotographic photosensitive member, a charge generation substance having a higher sensitivity has been used. However, as the sensitivity of the charge generation substance is improved, since a charge generation amount is increased, the charge is liable to stay in the vicinity of the interface between the photosensitive layer and the undercoat layer, and as a result, there has been a problem in that a ghost phenomenon is liable to occur. The ghost phenomenon is a phenomenon in which when an image forming process is continuously and repeatedly performed to output images, the history of image exposure in a previous image forming process remains on the electrophotographic photosensitive member, and this remaining image has an influence on the density of an image to be formed in the following image forming process. When the image density of a portion on which the history of the image exposure remains is increased, this portion is called a positive ghost, and when the image density is decreased, this portion is called a negative ghost.

As a technique to suppress the ghost phenomenon as described above, PTL 1 has disclosed a technique in which an undercoat layer contains metal oxide particles and a compound having an anthraquinone compound.

In addition, in recent years, since a higher process speed and a higher image quality of electrophotographic apparatuses have been desired because of the trend toward color image formation and the like, further improvement of the electrophotographic photosensitive member has been required. As one concrete requirement, reduction in ghost phenomenon under various use environments may be mentioned.

### CITATION LIST

### Patent Literature

PTL 1 Japanese Patent Laid-Open No. 2006-221094 Summary of Invention

### Technical Problem

Through intensive investigation carried out by the present inventors, it was found that by the technique disclosed by PTL 1, the problem of image degradation caused by a ghost phenomenon, in particular, by a ghost phenomenon under a high-temperature and high-humidity environment, is not sufficiently overcome and that the above technique still has some more room for improvement.

Accordingly, the present invention provides an electrophotographic photosensitive member which suppresses image degradation caused by a ghost phenomenon, in particular, by a ghost phenomenon under a high-temperature and high-humidity environment and a method for manufacturing the electrophotographic photosensitive member described above. In addition, the present invention also provides a process cartridge and an electrophotographic apparatus, each of which has the above electrophotographic photosensitive member.

### Solution to Problem

The present invention relates to an electrophotographic photosensitive member including a support, an undercoat layer formed on the support, and a photosensitive layer formed on the undercoat layer, and the undercoat layer contains metal oxide particles and a compound represented by the following formula (1).

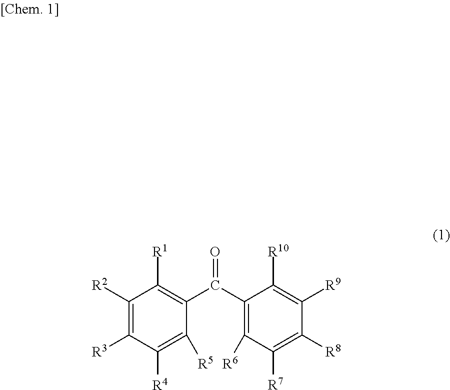

(In the formula (1), R¹ to R¹⁰ each independently represents a hydrogen atom, a halogen atom, a hydroxy group, a carboxyl group, an unsubstituted or substituted alkyl group, or an unsubstituted or substituted alkoxy group, and R⁵ and R⁶ together may form a single bond. However, at least one of R¹ to R¹⁰ represents a carboxyl group.)

In addition, the present invention relates to a process cartridge which integrally supports the above electrophotographic photosensitive member and at least one unit selected from the group consisting of a charging unit, a developing unit, a transferring unit, and a cleaning unit and which is detachable to a main body of an electrophotographic apparatus.

In addition, the present invention relates to an electrophotographic apparatus including the above electrophotographic photosensitive member, a charging unit, an exposure unit, a developing unit, and a transferring unit.

In addition, the present invention relates to a method for manufacturing an electrophotographic photosensitive member which includes an undercoat layer formed on a support and a photosensitive layer formed on the undercoat layer, the method comprising: forming a coating film from an undercoat-layer coating solution containing metal oxide particles and a compound represented by the following formula (1); and heating and drying the coating film to form the undercoat layer.

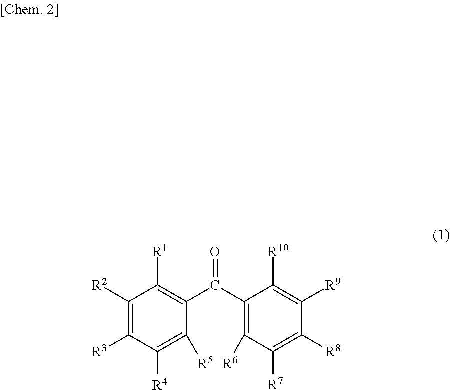

(In the formula (1), R¹ to R¹⁰ each independently represents a hydrogen atom, a halogen atom, a hydroxy group, a carboxyl group, an unsubstituted or substituted alkyl group, or an unsubstituted or substituted alkoxy group, and R⁵ and R⁶ together may form a single bond. However, at least one of R¹ to R¹⁰ represents a carboxyl group.)

### Advantageous Effects of Invention

According to the present invention, an electrophotographic photosensitive member which suppresses image degradation caused by a ghost phenomenon, in particular, by a ghost phenomenon under a high-temperature and high-humidity environment and a method for manufacturing the above electrophotographic photosensitive member are provided. In addition, according to the present invention, a process cartridge and an electrophotographic apparatus, each of which has the above electrophotographic photosensitive member, are provided.

### BRIEF DESCRIPTION OF DRAWINGS

FIG. 1 is a schematic view showing one example the structure of an electrophotographic apparatus including a process cartridge which has an electrophotographic photosensitive member.

FIG. 2 is a view showing one example of a layer structure of the electrophotographic photosensitive member.

FIG. 3 is a view showing a ghost evaluation image.

FIGS. 4A and 4B are each a schematic view obtained when a halftone image of FIG. 3 is enlarged.

### DESCRIPTION OF EMBODIMENTS

According to the present invention, an undercoat layer of an electrophotographic photosensitive member contains metal oxide particles and a compound represented by the following formula (1).

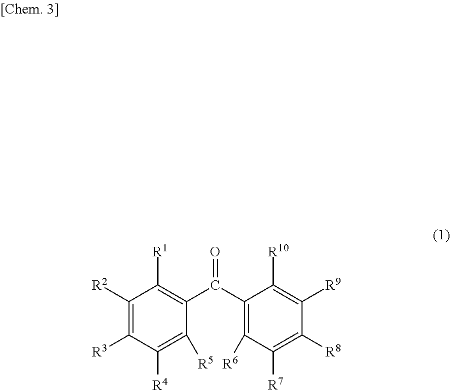

In the formula (1), R¹ to R¹⁰ each independently represent a hydrogen atom, a halogen atom, a hydroxy group, a carboxyl group, an unsubstituted or substituted alkyl group, or an unsubstituted or substituted alkoxy group, and R⁵ and R⁶ together may form a single bond. However, at least one of R¹ to R¹⁰ represents a carboxyl group. As a substituent of the substituted alkyl group, for example, an alkoxy group, a halogen atom, or a hydroxy group may be mentioned. As a substituent of the substituted alkoxy group, for example, an alkoxy group, a halogen atom, or a hydroxy group may be mentioned.

As one example in which R⁵ and R⁶ together form a single bond, for example, a compound represented by the following formula (3) and in more particular, compounds represented by formulas (1-17) to (1-28) may be mentioned.

Among those mentioned above, in view of interaction with the metal oxide particles, in the compound represented by the formula (1), R¹ to R¹⁰ each preferably independently represent a hydrogen atom, a hydroxy group, or a carboxyl group, and at least one of R¹ to R¹⁰ preferably represents a carboxyl group. Alternatively, R¹ to R⁴ and R⁷ to R¹⁰ each preferably independently represent a hydrogen atom, a hydroxy group, or a carboxyl group, R⁵ and R⁶ preferably together form a single bond, and at least one of R¹ to R⁴ and R⁷ to R¹⁰ preferably represents a carboxyl group. As the compound represented by the formula (1), a compound represented by the following formula (2) or a compound represented by the following formula (3) is more preferable. In addition, the compound represented by the following formula (3) is a compound obtained when R⁵ and R⁶ of the above formula (1) together form a single bond.

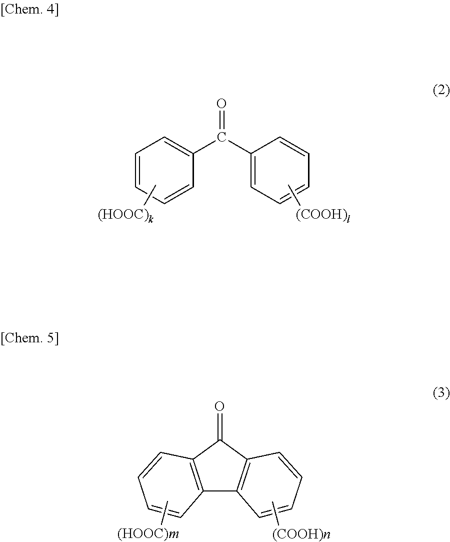

In the above formula (2), k and l each represent an integer of 0 or more, and the total of k and l is 1 to 3. In the above formula (3), m and n each represent an integer of 0 or more, and the total of m and n is 1 or 2.

The reason the ghost phenomenon is significantly suppressed when the undercoat layer contains the metal oxide particles and the compound represented by the above formula (1) has been construed as described below by the present inventors.

The compound represented by the above formula (1) is a benzophenone compound having at least one carboxyl group or a fluorenone compound having at least one carboxyl group. Because of the benzophenone skeleton and the fluorenone skeleton, the compounds described above are each considered to have a high dipole moment and to be likely to draw electric charges. In addition, it is also considered that the compound represented by the above formula (1) and the metal oxide particles interact with each other to form an intramolecular charge transfer complex (composite).

In this case, since the compound represented by the above formula (1) has at least one carboxyl group, it is believed that the interaction with the metal oxide particles is further enhanced. In particular, under a high-temperature and high-humidity environment, the undercoat layer absorbs moisture, and by the moisture thus absorbed, the formation of the intramolecular charge transfer complex tends to be suppressed. However, it is construed that since the compound represented by the above formula (1) of the present invention has a carboxyl group, the inhibition of the formation of the intramolecular charge transfer complex, which is caused by moisture, is suppressed, and as a result, the intramolecular charge transfer complex is stably formed.

As described above, since the intramolecular charge transfer complex of the compound represented by the above formula (1) and the metal oxide particles is formed in the undercoat layer, it is believed that the undercoat layer is placed in a state ready to receive electric charges (electrons). Hence, it is construed that since electrons generated in the photosensitive layer (charge generation layer) by image exposure irradiation are able to rapidly move toward an undercoat layer side, the retention of charge at the interface between the photosensitive layer and the undercoat layer is suppressed. In addition, it is construed that by the compound represented by the above formula (1), the transfer of electrons between adjacent metal oxide particles is also smoothly performed in the undercoat layer, and as a result, the retention of charge in the undercoat layer is suppressed. Accordingly, the present inventors believed that since the retention of electric charge is suppressed not only at the interface between the photosensitive layer and the undercoat layer but also in the undercoat layer, the ghost phenomenon is suppressed from being generated.

Hereinafter, although particular examples of the compound represented by the formula (1) are shown, the present invention is not limited thereto.

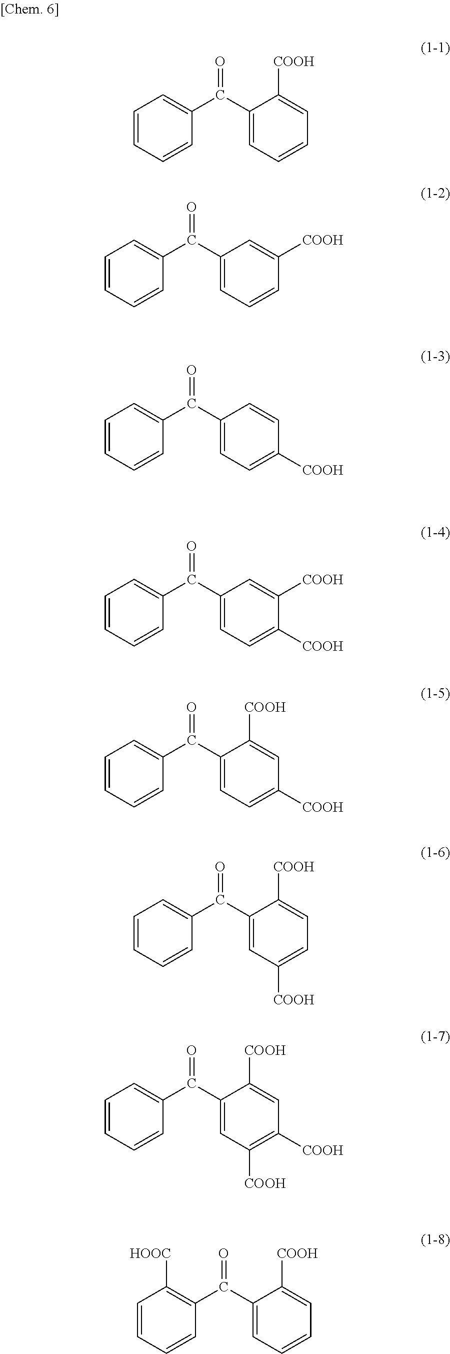

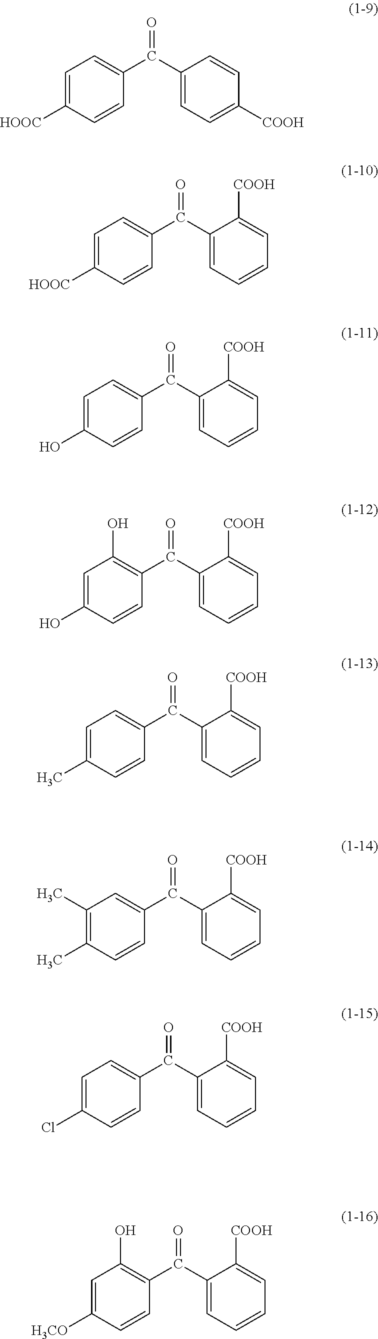

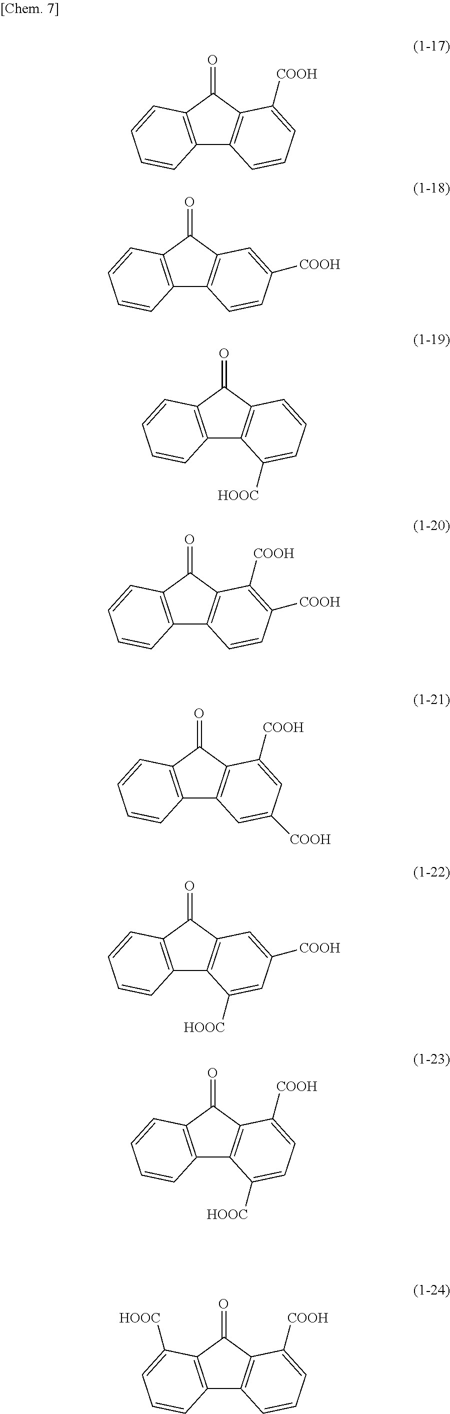

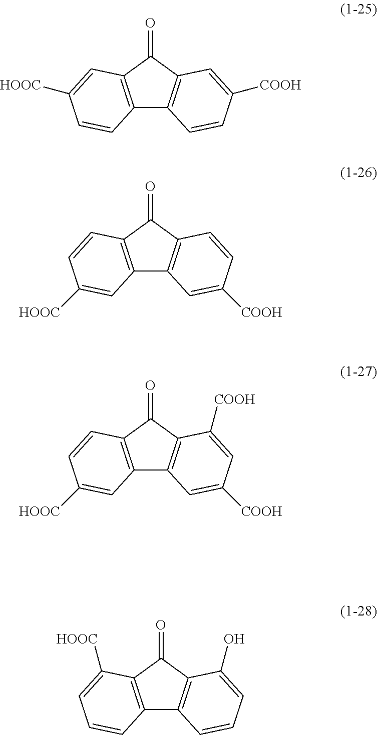 [SMILES: O=C(O)c1ccc2c(c1)C(=O)c1cc(C(=O)O)ccc1-2 ; O=C(O)c1ccc2c(c1)-c1cc(C(=O)O)ccc1C2=O ; O=C(O)c1ccc2c(c1)-c1cc(C(=O)O)cc(C(=O)O)c1C2=O ; O=C(O)c1cccc2c1C(=O)c1c(O)cccc1-2]

Among those compounds, the compounds represented by the above formulas (1-1), (1-2), (1-3), (1-7), (1-9), (1-17), (1-18), (1-19), and (1-25) are preferable.

In addition, the content of the compound represented by the above formula (1) in the undercoat layer is preferably in a range of 0.05 to 4 percent by mass with respect to the metal oxide particles in the undercoat layer. When the content is 0.05 percent by mass or more, the compound represented by the above formula (1) and the metal oxide particles sufficiently interact with each other, and hence, an excellent effect of suppressing a ghost phenomenon is obtained. On the other hand, when the content is 4 percent by mass or less, an interaction between the compound molecules represented by the above formula (1) is suppressed, and hence, an excellent effect of suppressing a ghost phenomenon is obtained.

The undercoat layer preferably further contains a binder resin. As the binder resin, for example, there may be mentioned an acrylic resin, an allyl resin, an alkyd resin, an ethyl cellulose resin, an ethylene-acrylic acid copolymer, an epoxy resin, a casein resin, a silicone resin, a gelatin resin, a phenol resin, a butyral resin, a polyacrylate resin, a polyacetal resin, a poly(amide imide) resin, a polyamide resin, a poly(allyl ether) resin, a polyimide resin, a polyurethane resin, a polyester resin, a polyethylene resin, a polycarbonate resin, a polystyrene resin, a polysulfone resin, a poly(vinyl alcohol) resin, a polybutadiene resin, and a polypropylene resin. Among those mentioned above, a polyurethane resin is preferable.

The content of the binder resin in the undercoat layer is preferably in a range of 10 to 50 percent by mass with respect to the metal oxide particles. When the content is in a range of 10 to 50 percent by mass, the uniformity of a coating film for the undercoat layer is improved.

As the type of metal oxide particles contained in the undercoat layer, for example, particles containing titanium oxide, zinc oxide, tin oxide, zirconium oxide, or aluminum oxide may be mentioned. In addition, particles containing at least one type selected from the group consisting of titanium oxide and zinc oxide are preferable.

The metal oxide particles may be particles having surfaces processed by a surface treatment agent such as a silane coupling agent. As the silane coupling agent, for example, there may be mentioned N-2-(aminoethyl)-3-aminopropyl methyl dimethoxy silane, 3-aminopropyl methyl dimethoxy silane, phenyl-aminomethyl methyl dimethoxy silane, N-2-(aminoethyl)-3-aminoisobutyl methyl dimethoxy silane, N-ethylamino-isobutyl methyl diethoxy silane, N-methylamino-propyl methyl dimethoxy silane, vinyl trimethoxy silane, 3-aminopropyl trimethoxy silane, N-(2-aminoethyl)-3-aminopropyl trimethoxy silane, 3-glycidoxypropyl trimethoxy silane, 3-methacryloxy-propyl trimethoxy silane, 3-chloropropyl trimethoxy silane, and 3-mercaptopropyl trimethoxy silane.

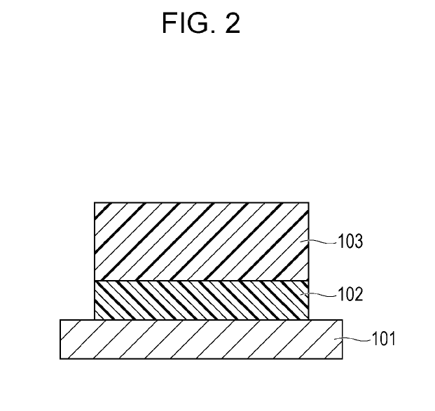

The electrophotographic photosensitive member of the present invention includes a support, an undercoat layer provided on the support, and a photosensitive layer provided on the undercoat layer. FIG. 2 is a view showing one example of a layer structure of the electrophotographic photosensitive member. In FIG. 2, reference numeral 101 indicates the support, reference numeral 102 indicates the undercoat layer, and reference numeral 103 indicates the photosensitive layer.

As the photosensitive layer, there may be mentioned a single-layer type photosensitive layer containing a charge generation substance and a charge transport substance in one layer and a laminate type (function-separated type) photosensitive layer including a charge generation layer which contains a charge generation substance and a charge transport layer which contains a charge transport substance. In the present invention, a laminate type photosensitive layer including a charge generation layer and a charge transport layer provided thereon is preferable. In addition, on the photosensitive layer, a protective layer (second charge transport layer) may be further formed.

### Support

As the support, a material (conductive support) having conductivity is preferable. For example, a metal or an alloy, each of which includes aluminum, stainless steel, copper, nickel, zinc, or the like, may be mentioned. In the case of a support formed of aluminum or an aluminum alloy, an ED tube or an EI tube, each of which is processed with or without a cutting, an electrolytic compound polishing, or a wet or a dry honing treatment, may be used. In addition, there may also be mentioned a support prepared by forming a thin film of a conductive material, such as aluminum, an aluminum alloy, or an indium oxide-tin oxide alloy, on a metal support or a resin-made support. In addition, as the shape of the support, although a cylindrical, a belt, and a sheet shape may be mentioned, a cylindrical shape is more preferable.

In addition, in order to suppress an interference pattern caused by scattering of laser light, the surface of the support may be processed by a cutting treatment, a surface-roughening treatment, or an alumite treatment.

In order to suppress an interference pattern caused by scattering of laser light and to cover scratches of the support, a conductive layer may be provided between the support and the undercoat layer. The conductive layer may be formed in such a way that after a coating film is formed from a conductive-layer coating solution which is obtained by dispersing conductive particles, such as carbon black, with a binder resin and a solvent, heating and drying (heat curing) are performed on the coating film.

As the binder resin used for the conductive layer, for example, a polyester resin, a polycarbonate resin, a poly(vinyl butyral) resin, an acrylic resin, a silicone resin, an epoxy resin, a melamine resin, a urethane resin, a phenol resin, and an alkyd resin may be mentioned.

As the solvent of the conductive-layer coating solution, for example, an ether solvent, an alcohol solvent, a ketone solvent, and an aromatic hydrocarbon solvent may be mentioned. The thickness of the conductive layer is preferably 5 to 40 μm and in particular, is more preferably 10 to 30 μm.

### Undercoat Layer

Between the photosensitive layer (charge generation layer in the case of a laminate type photosensitive layer) and the support or the conductive layer, the undercoat layer described above is provided. The undercoat layer further contains a binder resin besides the compound represented by the above formula (1) and the metal oxide particles.

The undercoat layer may be formed in such a way that after a coating film is formed from an undercoat-layer coating solution obtained by dispersing the metal oxide particles, the compound represented by the above formula (1), and the binder resin with a solvent, heating and drying are performed on the coating film. In addition, as the undercoat-layer coating solution, there may be used a solution obtained in such a way that after a solution dissolving the binder resin is added to a dispersion liquid obtained by dispersing the metal oxide particles and the compound represented by the above formula (1) with a solvent, a dispersion treatment is further performed on the mixture thus obtained. As a dispersion method, for example, a method using a homogenizer, an ultrasonic dispersion machine, a ball mill, a sand mill, a roll mill, a vibration mill, an attritor, or a liquid collision type high-speed dispersion machine may be mentioned.

As the solvent used for the undercoat-layer coating solution, for example, there may be mentioned an alcohol solvent, a sulfoxide solvent, a ketone solvent, an ether solvent, an ester solvent, an aliphatic halogenated hydrocarbon solvent, and an aromatic hydrocarbon solvent.

The undercoat layer may further contain organic resin fine particles and/or a leveling agent. The thickness of the undercoat layer is preferably in a range of 0.5 to 50 μm and in particular, is more preferably in a range of 1 to 35 μm.

The content of the compound represented by the above formula (1) in the undercoat-layer coating solution is preferably in a range of 0.05 to 4 percent by mass with respect to the metal oxide particles in the undercoat-layer coating solution. When the content is 0.05 percent by mass or more, in the undercoat layer to be formed, the compound represented by the above formula (1) and the metal oxide particles sufficiently interact with each other, and a superior effect of suppressing a ghost phenomenon is obtained. When the content is 4 percent by mass or less, an interaction between the compound molecules represented by the above formula (1) is suppressed, and hence, a superior effect of suppressing a ghost phenomenon is obtained.

### Photosensitive Layer

A photosensitive layer containing a charge generation substance and a charge transport substance is formed on the undercoat layer. As described above, the photosensitive layer may be either a single-layer type photosensitive layer or a laminate type photosensitive layer.

As the charge generation substance, for example, there may be mentioned an azo pigment, a phthalocyanine pigment, an indigo pigment, a perylene pigment, a polycyclic quinone pigment, a squarylium dye, a thiapyrylium salt, a triphenylmethane dye, a quinacridone pigment, an azlenium salt pigment, a cyanine dye, an anthanthrone pigment, a pyranthrone pigment, a xanthene dye, a quinoneimine dye, and a styryl dye. Those charge generation substances may be used alone, or at least two types thereof may be used in combination. Among those charge generation substances, since being superior in photosensitivity, a phthalocyanine pigment and an azo pigment are preferable, and in particular, a phthalocyanine pigment is more preferable.

In addition, in the phthalocyanine pigment, in particular, an oxititanium phthalocyanine, a chlorogallium phthalocyanine, or a hydroxygallium phthalocyanine is preferably used since having a superior charge generation efficiency. Furthermore, in the hydroxygallium phthalocyanine, in view of the sensitivity, a hydroxygallium phthalocyanine crystal having peaks at Bragg angles 2θ of 7.4°±0.3° and 28.2°±0.3° in CuKα characteristic X-ray diffraction is more preferable.

In the case of the laminate type photosensitive layer, as a binder resin used for the charge generation layer, for example, there may be mentioned an acrylic resin, an allyl resin, an alkyd resin, an epoxy resin, a diallyl phthalate resin, a styrene-butadiene copolymer, a butyral resin, a benzal resin, a polyacrylate resin, a polyacetal resin, a poly(amide imide) resin, a polyamide resin, a poly(allyl ether) resin, a polyarylate resin, a polyimide resin, a polyurethane resin, a polyester resin, a polyethylene resin, a polycarbonate resin, a polystyrene resin, a polysulfone resin, a poly(vinyl acetal) resin, a polybutadiene resin, a polypropylene resin, a methacrylic resin, a urea resin, a vinyl chloride-vinyl acetate copolymer, a vinyl acetate resin, and a vinyl chloride resin. Among those mentioned above, in particular, a butyral resin is preferable. Those binder resins mentioned above may be used alone or may be used as at least one component of a copolymer or a mixture.

The charge generation layer may be formed in such a way that after a charge generation-layer coating solution which is obtained by performing a dispersion treatment on the charge generation substance together with the binder resin and a solvent is applied to form a coating film, the coating film thus obtained is then heated and dried. In addition, the charge generation layer may also be formed by deposition of the charge generation substance.

As a dispersion treatment method, for example, a method using a homogenizer, an ultrasonic dispersion machine, a ball mill, a sand mill, a roll mill, a vibration mill, an attritor, or a liquid collision type high-speed dispersion machine may be mentioned.

As the ratio of the charge generation substance to the binder resin, with respect to one part by mass of the binder resin, 0.3 to 10 parts by mass of the charge generation substance is preferable.

As the solvent used for the charge generation-layer coating solution, for example, an alcohol solvent, a sulfoxide solvent, a ketone solvent, an ether solvent, an ester solvent, an aliphatic halogenated hydrocarbon solvent, and an aromatic hydrocarbon solvent may be mentioned. The thickness of the charge generation layer is preferably in a range of 0.01 to 5 μm and in particular, is more preferably in a range of 0.1 to 2 μm. In addition, to the charge generation layer, various additives, such as a sensitizer, an antioxidant, a UV absorber, and a plasticizer, may be added if needed.

In the case of the laminate type photosensitive member, the charge transport layer is formed on the charge generation layer. As the charge transport substance, for example, a triarylamine compound, a hydrazone compound, a styryl compound, a stilbene compound, and a butadiene compound may be mentioned. Those charge transport substances may be used alone, or at least two types thereof may be used in combination. Among those mentioned above, in view of charge mobility, a triarylamine compound is preferable.

In the case of the laminate type photosensitive member, as a binder resin used for the charge transport layer, for example, there may be mentioned an acrylic resin, an acrylonitrile resin, an allyl resin, an alkyd resin, an epoxy resin, a silicone resin, a phenol resin, a phenoxy resin, a polyacrylamide resin, a poly(amide imide) resin, a polyamide resin, a poly(allyl ether) resin, a polyarylate resin, a polyimide resin, a polyurethane resin, a polyester resin, a polyethylene resin, a polycarbonate resin, a polysulfone resin, a poly(phenylene oxide) resin, a polybutadiene resin, a polypropylene resin, and a methacrylic resin. Among those mentioned above, a polyarylate resin and a polycarbonate resin are preferable. Those binder resins mentioned above may be used alone or may be used as at least one component of a mixture or a copolymer.

The charge transport layer may be formed in such a way that after a charge transport-layer coating solution which is obtained by dissolving the charge transport substance and the binder resin in a solvent is applied to form a coating film, the coating film thus obtained is then heated and dried. As the ratio of the charge transport substance and the binder resin in the charge transport layer, with respect to one part by mass of the binder resin, 0.3 to 10 parts by mass of the charge transport substance is preferable. In addition, in order to suppress the generation of cracks in the charge transport layer, the drying temperature is preferably in a range of 60° C. to 150° C. and more preferably in a range of 80° C. to 120° C. In addition, the drying time is preferably in a range of 10 to 60 minutes.

As the solvent used for the charge transport-layer coating solution, for example, there may be mentioned an alcohol solvent, such as propanol or butanol, an aromatic hydrocarbon solvent, such as anisole, toluene, xylene, or chlorobenzene, methyl cyclohexane, or ethyl cyclohexane.

The thickness of the charge transport layer is preferably in a range of 5 to 40 μm and more preferably in a range of 5 to 30 μm. When the charge transport layer is configured to have a laminate structure, the thickness of a charge transport layer located at a support side is preferably in a range of 5 to 30 μm, and the thickness of a charge transport layer located at a surface side is preferably in a range of 1 to 10 μm.

In addition, to the charge transport layer, an antioxidant, a UV absorber, a plasticizer, a leveling agent, and the like may also be added if needed.

### Protective Layer (Second Charge Transport Layer)

For example, in order to protect the photosensitive layer and to improve wear resistance or cleaning properties, a protective layer (second charge transport layer) may be provided on the photosensitive layer (charge transport layer).

The protective layer may be formed in such a way that after a protective-layer coating solution which is obtained by dissolving a binder resin in an organic solvent is applied to form a coating film, this coating film is then heated and dried. As the resin used for the protective layer, for example, there may be mentioned a poly(vinyl butyral) resin, a polyester resin, a polycarbonate resin, a polyamide resin, a polyimide resin, a polyarylate resin, a polyurethane resin, a styrene-butadiene copolymer, a styrene-acrylic, acid copolymer, and a styrene-acrylonitrile copolymer. In order to enable the protective layer to have a charge transport function, a charge transport substance similar to that used in the above charge transport layer may be contained in the protective layer.

In addition, in order to further improve the charge transport function and the wear resistance, the protective layer may be formed by curing a monomer material having a charge transport function or a high molecular weight type charge transport substance using various cross-linking reactions. The protective layer is preferably a cured layer formed by polymerizing or cross-linking a charge transport substance having a chain polymerizable functional group. As the chain polymerizable functional group, for example, there may be mentioned an acrylic group, a methacrylic group, an alkoxy silyl group, and an epoxy group. As a method for polymerizing or cross-linking a compound having the chain polymerizable functional groups as described above, for example, there may be mentioned radical polymerization, ion polymerization, heat polymerization, photo polymerization, radiation polymerization (electron beam polymerization), a plasma CVD method, and a photo-CVD method.

The thickness of the protective layer is preferably in a range of 0.5 to 10 μm and more preferably in a range of 1 to 7 μm. In addition, if needed, additives, such as conductive particles, an antioxidant, and an UV absorber, may be contained in the protective layer.

In the outermost surface layer (the charge transport layer or the protective layer) of the electrophotographic photosensitive member, a lubricant agent, such as a silicone oil, a wax, fluorine-containing resin particles, such as polytetrafluoroethylene particles, silica particles, alumina particles, or boron nitride, may be contained.

When the above coating solution for each layer is applied, a coating method, such as a dipping application method (dipping coating method), a spray coating method, a spinner coating method, a roller coating method, a mayer bar coating method, or a blade coating method, may be used.

### Electrophotographic Apparatus

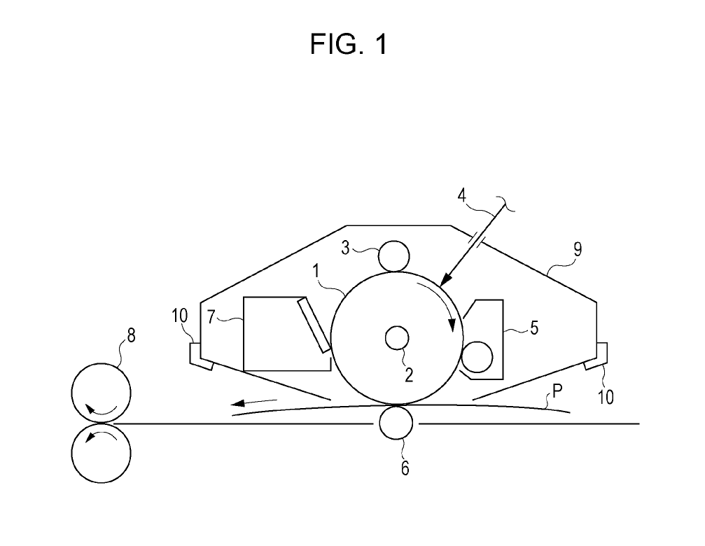

FIG. 1 shows a schematic structure of an electrophotographic apparatus including a process cartridge which has an electrophotographic photosensitive member. However, the structure of the electrophotographic apparatus shown below is merely one example, and the structure thereof is not limited thereto. In FIG. 1, a cylindrical electrophotographic photosensitive member 1 is rotatably driven around a shaft 2 in an arrow direction at a predetermined circumferential velocity (process speed). The surface of the electrophotographic photosensitive member 1 which is rotatably driven is uniformly charged at a negative predetermined potential in a rotation process by a charging unit 3, such as corona charging device or a charging roller. Next, the surface of the electrophotographic photosensitive member 1 receives image exposure light 4 which is outputted from an exposure unit (not shown), such as laser beam scanning exposure or an LED array, and which is intensity-modified in accordance with a time-series electrical digital image signal of target image information. Accordingly, on the surface of the electrophotographic photosensitive member 1, an electrostatic latent image in accordance with the target image information is sequentially formed.

The electrostatic latent image formed on the surface of the electrophotographic photosensitive member 1 is then developed by reversal development with toner contained in a developing agent in a developing unit 5, so that a toner image is formed. Next, the toner image formed and carried on the surface of the electrophotographic photosensitive member 1 is sequentially transferred to a transfer medium (such as paper) P by a transferring bias from a transferring unit 6 (such as a transfer roller). In this case, the transfer medium P is taken out of a transfer medium feeding unit (not shown) in synchronous with the rotation of the electrophotographic photosensitive member 1 and is then fed so as to be inserted into a contact portion between the electrophotographic photosensitive member 1 and the transferring unit 6. In addition, a bias voltage having a polarity opposite to that of the charge of the toner is applied to the transferring unit 6 from a bias power source (not shown), and by the function of this bias voltage, the toner image is transferred from the surface of the electrophotographic photosensitive member 1 to the surface of the transfer medium P.

After the transfer medium P to which the toner image is transferred is separated from the surface of the electrophotographic photosensitive member 1 and is then conveyed to a fixing unit 8, the toner image is processed by a fixing treatment to form an image forming material, and this image forming material is then conveyed out of the apparatus.

The surface of the electrophotographic photosensitive member 1 after the toner image is transferred therefrom is cleaned by removing a developing agent (residual toner) remaining after the transfer using a cleaning unit 7 (such as a cleaning blade). In the case of a cleanerless system, the residual toner remaining after the transfer may be directly recovered, for example, by a developing unit. Next, after being discharged by pre-exposure light (not shown) emitted from a pre-exposure unit (not shown), the surface of the electrophotographic photosensitive member 1 is repeatedly used for image formation. In addition, as shown in FIG. 1, when the charging unit 3 is a contact charging unit using a charging roller or the like, the pre-exposure may not be always necessary.

In the present invention, among the constituent elements, such as the electrophotographic photosensitive member 1, the charging unit 3, the developing unit 5, the transferring unit 6, and the cleaning unit 7, a plurality thereof may be selected and stored in a container and may then be integrally supported with each other to form a process cartridge. In addition, this process cartridge may be configured so as to be detachable to a main body of the electrophotographic apparatus, such as a copying machine or a laser printer. In FIG. 1, the charging unit 3, the developing unit 5, and the cleaning unit 7 are integrally supported together with the electrophotographic photosensitive member 1 to form a cartridge, so that a process cartridge 9 detachable to the main body of the electrophotographic apparatus using a guide unit 10, such as a rail, is formed.

### EXAMPLES

Hereinafter, the present invention will be described in more detail with reference to concrete examples. However, the present invention is not limited to those described below. In addition, “part(s)” in Examples indicates “part(s) by mass”.

### Example 1

As a support (conductive support), an aluminum cylinder having a diameter of 30 mm and a length of 357.5 mm was used.

Next, after 100 parts of zinc oxide particles (specific surface area: 19 m²/g, powder resistivity: 4.7×10⁶ Ω·cm) functioning as metal oxide particles were stirred and mixed with 500 parts of toluene, 0.8 parts of a silane coupling agent (compound name: N-2-(aminoethyl)-3-aminopropyl methyl dimethoxy silane, trade name: KBM-602, manufactured by Shin-Etsu Chemical Co., Ltd.) was added to this mixture, and stirring was then performed for 6 hours. Subsequently, toluene was removed by reduced-pressure distillation, and heating and drying were then performed at 130° C. for 6 hours, so that surface-treated zinc oxide particles were obtained.

Next, 15 parts of a butyral resin (trade name: BM-1, manufactured by Sekisui Chemical Co., Ltd.) and 15 parts of blocked isocyanate (trade name: Sumidur 3175, manufactured by Sumitomo Bayer Urethane Co., Ltd.) were dissolved in a mixed solution of 73.5 parts of methyl ethyl ketone and 73.5 parts of 1-butanol. To the solution thus prepared, 80.8 parts of the surface-treated zinc oxide particles and 1.62 pats (2 percent by mass to the zinc oxide particles) of the compound represented by the above formula (1-1) (manufactured by Tokyo Chemical Industry Co., Ltd.) were added. The mixture thus obtained was dispersed in an atmosphere at a temperature of 23° C.±3° C. for 3 hours by a sand mill machine using glass beads having a diameter of 0.8 mm. After the dispersing was performed, 0.01 parts of a silicone oil (trade name: SH28PA, manufactured by Dow Corning Toray Co., Ltd.) and 5.6 parts of cross-linked poly(methyl methacrylate) (PMMA) particles (trade name: TECHPOLYMER SSX-102, manufactured by Sekisui Plastics Co., Ltd., average primary particle diameter: 2.5 μm) were added and stirred, thereby preparing an undercoat-layer coating solution. This undercoat-layer coating solution was applied on the support by dipping application to form a coating film, and the coating film thus obtained was heated and dried at 160° C. for 40 minutes, so that an undercoat layer having a film thickness of 18 μm was formed.

Next, 4 parts of a hydroxygallium phthalocyanine crystal (charge generation substance) having peaks at Bragg angles 2θ±0.2° of 7.4° and 28.1° in CuKα characteristic X-ray diffraction and 0.04 parts of a compound represented by the following formula (A) were added to a solution in which 2 parts of a poly(vinyl butyral) resin (trade name: S-LEC BX-1, manufactured by Sekisui Chemical Co., Ltd.) was dissolved in 100 parts of cyclohexane. Subsequently, after a dispersion treatment was performed in an atmosphere at a temperature of 23° C.±3° C. for 1 hour by a sand mill machine using glass beads having a diameter of 1 mm, 100 parts of ethyl acetate was added, so that a charge generation-layer coating solution was prepared. This charge generation-layer coating solution was applied on the undercoat layer by dipping application to form a coating film, and the coating film thus obtained was dried at 90° C. for 10 minutes, so that a charge generation layer having a film thickness of 0.20 μm was formed.

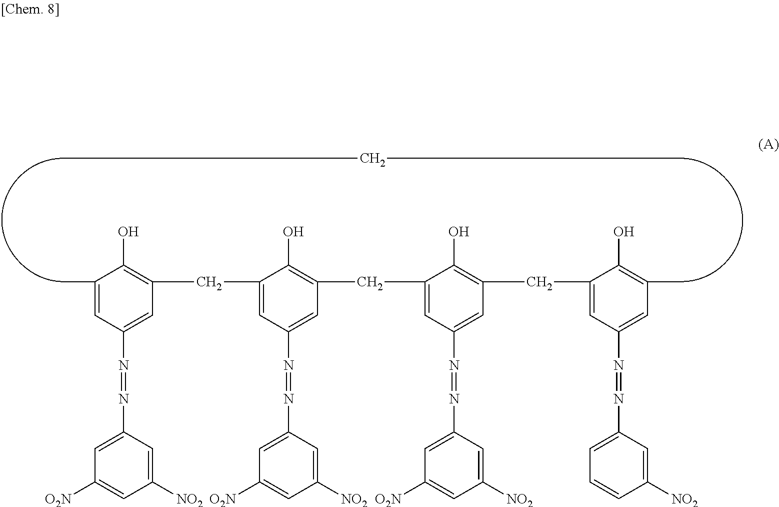

Next, 30 parts of a compound (charge transport substance) represented by the following formula (B), 60 parts of a compound (charge transport substance) represented by the following formula (C), 10 parts of a compound represented by the following formula (D), 100 parts of a polycarbonate resin (trade name: Iupilon 2400, bisphenol Z type polycarbonate, manufactured by Mitsubishi Engineering-Plastics Corporation), and 0.02 parts of a polycarbonate resin (viscosity average molecular weight Mv: 20,000) represented by the following formula (E) were dissolved in a mixed solvent containing 600 parts of mixed xylene and 200 parts of dimethoxymethane, so that a charge transport-layer coating solution was prepared. This charge transport-layer coating solution was applied on the charge generation layer by dipping application to form a coating film, and the coating film thus obtained was dried at 100° C. for 30 minutes, so that a charge transport layer (first charge transport layer) having a film thickness of 18 μm was formed.

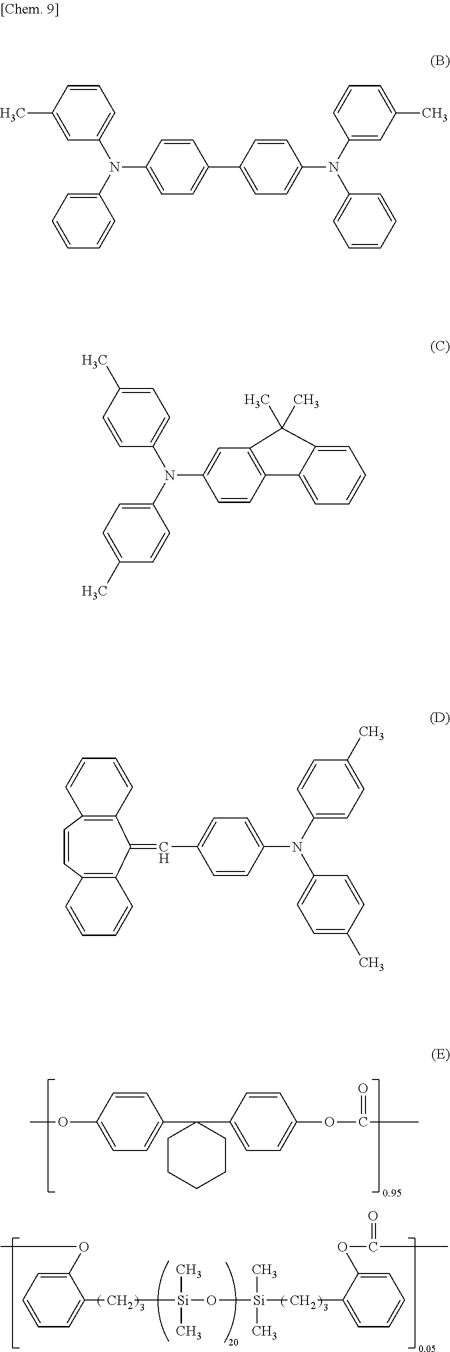

(In the formula (E), 0.95 and 0.05 indicate copolymer ratios of two types of repeating structural units, respectively.)

Next, 36 parts of a compound (charge transport substance having an acrylic group functioning as a chain polymerizable functional group) represented by the following formula (F), 4 parts of a polytetrafluoroethylene resin fine powder (Rublon L-2, manufactured by Daikin Industries, Ltd.), and 60 parts of n-propanol were dispersed and mixed together by an ultra-high pressure dispersing machine, so that a protective-layer coating solution (second charge transport-layer coating solution) was prepared.

This protective-layer coating solution was applied on the above charge transport layer by dipping application to form a coating film, and the coating film thus obtained was dried at a temperature of 50° C. for 5 minutes. After the drying was performed, the coating film was cured by irradiation with electron beams while the cylinder was rotated in a circumferential direction at a speed of 300 rotations per second in a nitrogen atmosphere having an oxygen concentration of 20 ppm. In this step, electron beams were irradiated for 1.6 seconds at an acceleration voltage of 70 kV and an absorption dose of 8,000 Gy. Subsequently, while the nitrogen atmosphere having an oxygen concentration of 20 ppm was maintained, the coating film was heat-treated for 3 minutes under the condition in which the temperature thereof reached 120° C. Next, in the air, a heat treatment was performed for 30 minutes under the condition in which the temperature of the coating film reached 100° C., so that a protective layer having a film thickness of 5 μm was formed.

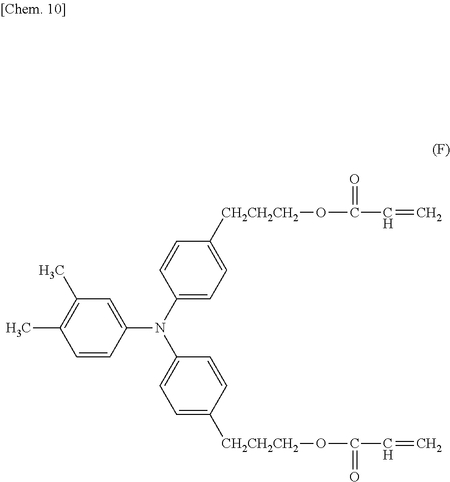

As described above, an electrophotographic photosensitive member having the support, the undercoat layer, the charge generation layer, the charge transport layer, and the protective layer in this order was manufactured.

### Examples 2 to 27

Except that in Example 1, the types and the contents of the metal oxide particles and the compound represented by the formula (1), which were used for the undercoat-layer coating solution, were set as shown in Table 1, an electrophotographic photosensitive member was manufactured in a manner similar to that in Example 1.

TABLE 1

| | | Compound Represented | |
|---|---|---|---|
| | | by Formula (1) | |
| | | Example | Content |
| Example | Metal Oxide Particles | Compound | (Percent by Mass) |
| 1 | Zinc Oxide Particles | (1-1) | 2 |
| 2 | Zinc Oxide Particles | (1-2) | 2 |
| 3 | Zinc Oxide Particles | (1-3) | 2 |
| 4 | Zinc Oxide Particles | (1-7) | 2 |
| 5 | Zinc Oxide Particles | (1-9) | 2 |
| 6 | Zinc Oxide Particles | (1-11) | 2 |
| 7 | Zinc Oxide Particles | (1-13) | 2 |
| 8 | Zinc Oxide Particles | (1-15) | 2 |
| 9 | Zinc Oxide Particles | (1-16) | 2 |
| 10 | Zinc Oxide Particles | (1-17) | 2 |
| 11 | Zinc Oxide Particles | (1-18) | 2 |
| 12 | Zinc Oxide Particles | (1-19) | 2 |
| 13 | Zinc Oxide Particles | (1-25) | 2 |
| 14 | Titanium Oxide Particles | (1-1) | 2 |
| 15 | Titanium Oxide Particles | (1-18) | 2 |
| 16 | Zinc Oxide Particles | (1-1) | 0.02 |
| 17 | Zinc Oxide Particles | (1-1) | 0.05 |
| 18 | Zinc Oxide Particles | (1-1) | 4 |
| 19 | Zinc Oxide Particles | (1-18) | 0.02 |
| 20 | Zinc Oxide Particles | (1-18) | 0.05 |
| 21 | Zinc Oxide Particles | (1-18) | 4 |
| 22 | Titanium Oxide Particles | (1-1) | 0.02 |
| 23 | Titanium Oxide Particles | (1-1) | 0.05 |
| 24 | Titanium Oxide Particles | (1-1) | 4 |
| 25 | Titanium Oxide Particles | (1-18) | 0.02 |
| 26 | Titanium Oxide Particles | (1-18) | 0.05 |
| 27 | Titanium Oxide Particles | (1-18) | 4 |

In addition, titanium oxide particles having a specific surface area of 20.5 m²/g and a powder resistivity of 60×10⁵ Ω·cm were used.

### Comparative Example 1

Except that in Example 1, the compound represented by the above formula (1-1) was not used, an electrophotographic photosensitive member was manufactured in a manner similar to that in Example 1.

### Comparative Example 2

Except that in Example 14, the compound represented by the above formula (1-1) was not used, an electrophotographic photosensitive member was manufactured in a manner similar to that in Example 14.

### Comparative Example 3

Except that in Example 1, the compound represented by the above formula (1-1) was changed to a compound represented by the following formula (E-1) (manufactured by Tokyo Chemical Industry Co., Ltd.), an electrophotographic photosensitive member was manufactured in a manner similar to that in Example 1.

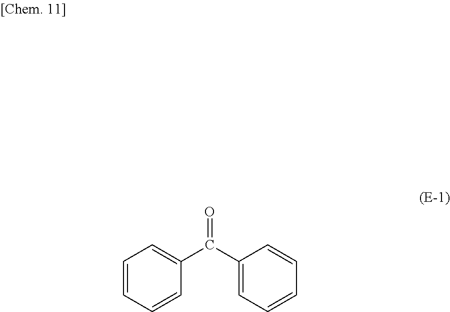 [SMILES: O=C(c1ccccc1)c1ccccc1]

### Comparative Example 4

Except that in Example 1, the compound represented by the above formula (1-1) was changed to a compound represented by the following formula (E-2) (manufactured by Tokyo Chemical Industry Co., Ltd.), an electrophotographic photosensitive member was manufactured in a manner similar to that in Example 1.

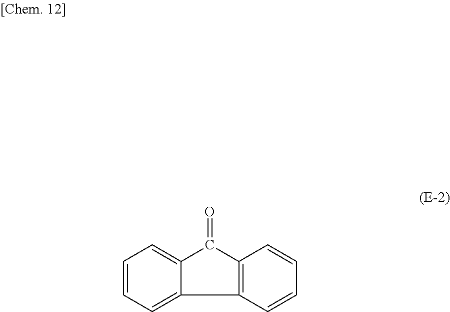 [SMILES: O=C1c2ccccc2-c2ccccc21]

### Comparative Example 5

Except that in Example 1, the compound represented by the above formula (1-1) was changed to a compound represented by the following formula (E-3) (manufactured by Tokyo Chemical Industry Co., Ltd.), an electrophotographic photosensitive member was manufactured in a manner similar to that in Example 1.

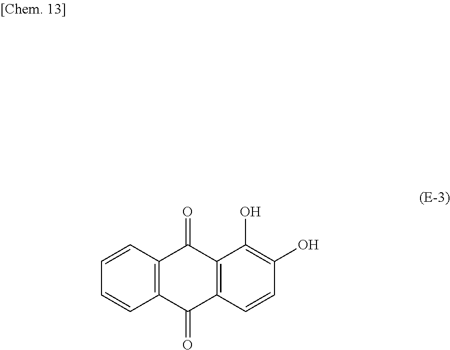 [SMILES: O=C1c2ccccc2C(=O)c2c1ccc(O)c2O]

### Comparative Example 6

Except that in Example 1, the compound represented by the above formula (1-1) was changed to a compound represented by the following formula (E-4) (manufactured by Tokyo Chemical Industry Co., Ltd.), an electrophotographic photosensitive member was manufactured in a manner similar to that in Example 1.

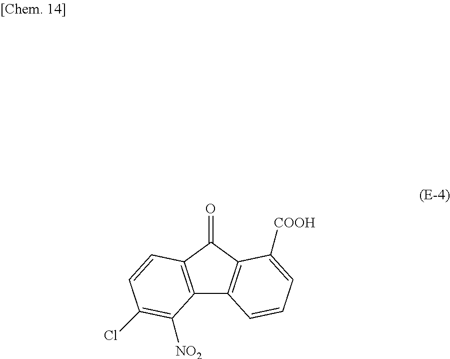 [SMILES: O=C(O)c1cccc2c1C(=O)c1ccc(Cl)c([N+](=O)[O-])c1-2]

### Comparative Example 7

Except that the charge generation layer was formed by changing as described below, an electrophotographic photosensitive member was manufactured in a manner similar to that in Comparative Example 1. In addition, as in Comparative Example 1, the compound represented by the formula (1) was not contained in the undercoat layer.

Next, 4 parts of a hydroxygallium phthalocyanine crystal (charge generation substance) having peaks at Bragg angles 2θ±0.2° of 7.4° and 28.1° in CuKα characteristic X-ray diffraction, 0.04 parts of the compound represented by the above formula (A), and 0.08 parts of the compound represented by the above formula (1-1) (manufactured by Tokyo Chemical Industry Co., Ltd.) were added to a solution in which 2 parts of a poly(vinyl butyral) resin (trade name: S-LEC BX-1, manufactured by Sekisui Chemical Co., Ltd.) was dissolved in 100 parts of cyclohexane. Subsequently, after a dispersion treatment was performed in an atmosphere at a temperature of 23° C.±3° C. for 1 hour by a sand mill machine using glass beads having a diameter of 1 mm, 100 parts of ethyl acetate was added, so that a charge generation-layer coating solution was prepared. This charge generation-layer coating solution was applied on the undercoat layer by dipping application, and a coating film thus obtained was dried at 90° C. for 10 minutes, so that a charge generation layer having a film thickness of 0.20 μm was formed. Next, on this charge generation layer, as in Comparative Example 1, a first charge transport layer and a second charge transport layer were formed in this order.

### Comparative Example 8

Except that in Comparative Example 7, the compound represented by the above formula (1-1) added to the charge generation layer was changed to the compound represented by the above formula (1-18) (manufactured by Tokyo Chemical Industry Co., Ltd.), an electrophotographic photosensitive member was manufactured in a manner similar to that in Comparative Example 7.

### Comparative Example 9

As in Comparative Example 1, an undercoat layer and a charge generation layer were formed on a support. Next, 30 parts of the compound (charge transport substance) represented by the above formula (B), 60 parts of the compound (charge transport substance) represented by the above formula (C), 10 parts of the compound represented by the above formula (D), 100 parts of the polycarbonate resin “Iupilon Z400”, 0.02 parts of the polycarbonate resin represented by the above formula (E), and 2 parts of the compound represented by the above formula (1-1) (manufactured by Tokyo Chemical Industry Co., Ltd.) were dissolved in a mixed solvent of 600 parts of mixed xylene and 200 parts of dimethoxymethane, so that a charge transport-layer coating solution was prepared. This charge transport-layer coating solution was applied on the charge generation layer by dipping application to form a coating film, and this coating film thus obtained was dried at 100° C. for 30 minutes, so that a charge transport layer having a film thickness of 18 μm was formed. As described above, an electrophotographic photosensitive member of Comparative Example 9 was manufactured.

### Comparative Example 10

Except that in Comparative Example 9, the compound represented by the above formula (1-1) added to the charge generation layer was changed to the compound represented by the above formula (1-18) (manufactured by Tokyo Chemical Industry Co., Ltd.), an electrophotographic photosensitive member was manufactured in a manner similar to that in Comparative Example 9.

### Evaluation

Before and after a repetitive use of the electrophotographic photosensitive member of each of Examples 1 to 27 and Comparative Examples 1 to 10 under a high-temperature and high-humidity environment, a ghost image evaluation was performed on the electrophotographic photosensitive member. As an electrophotographic apparatus used for evaluation, a copying machine obtained by modification of imageRUNNER ADVANCE C5051 manufactured by CANON KABUSHIKI KAISHA was used.

The electrophotographic photosensitive member was left to stand with the electrophotographic apparatus for 3 days under a high-temperature and high-humidity environment at a temperature of 30° C. and a relative humidity of 80%. Subsequently, the amount of laser light and the application voltage were adjusted so that the initial light potential and the initial dark potential were set to −100 V and −500 V, respectively, and an initial ghost image evaluation before repetitive printing was performed. In addition, in this case, the amount of pre-exposure was adjusted so that by irradiation of pre-exposure, the surface potential of the electrophotographic photosensitive member was changed from −500 V to −70 V. Subsequently, under the same environment as described above, repetitive printing was performed using 2,000 sheets, and immediately after this sheet passing test, the ghost image evaluation was performed. The evaluation results are shown in Table 2. The repetitive printing of the electrophotographic photosensitive member was performed under the conditions so that lines each having a width of 0.5 mm were printed in a longitudinal direction at intervals of 10 mm in an intermittent mode in which 4 sheets were printed for one minute.

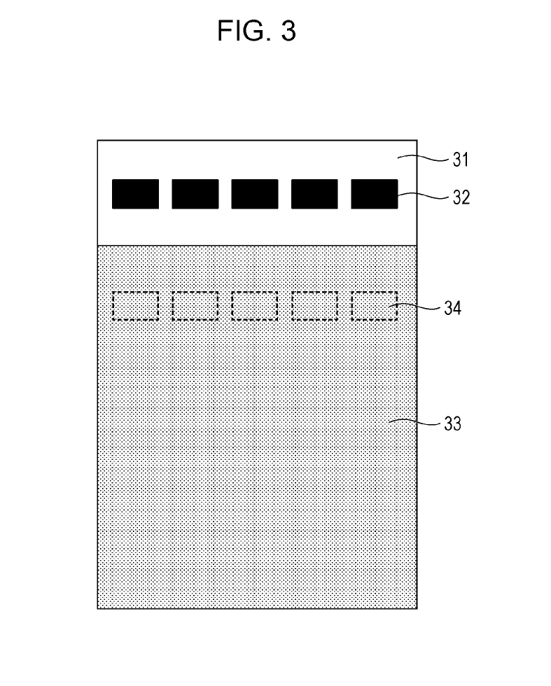

The ghost image evaluation was performed in such a way that after a ghost evaluation image was printed out, the degree of ghost on the output image was evaluated. As the ghost evaluation image, an image shown in FIG. 3 was used. As shown in FIG. 3, after solid black images 32 were formed on a white background (white image) 31, a halftone image 33 was formed. In FIG. 3, a portion 34 enclosed by a dotted line is a ghost evaluation portion derived from the solid black image 32 to evaluate whether a ghost appears or not.

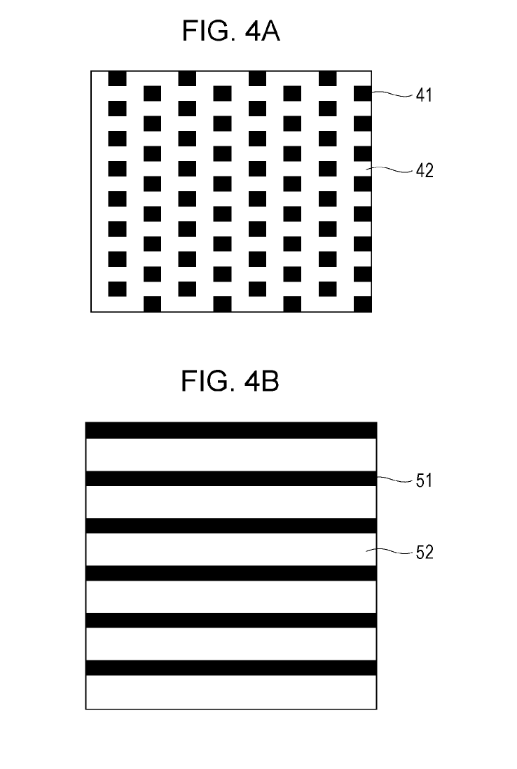

As the halftone image 33 in FIG. 3, two types of images having different image patterns were used, that is, a halftone image shown in FIG. 4A and a halftone image shown in FIG. 4B were used. FIGS. 4A and 4B are schematic views obtained when the halftone images are respectively enlarged. In FIG. 4A, reference numeral 41 indicates a black point formed by irradiation of one dot of laser beam, and reference numeral 42 indicates a white background portion which is not irradiated with laser beams. In FIG. 4B, reference numeral 51 indicates one black line formed in a bus bar direction of the electrophotographic photosensitive member, and the width of the line corresponds to one dot of laser beam. In FIG. 4B, reference numeral 52 indicates a white background portion on which the above black lines are not formed, and the width thereof corresponds to two dots of laser beams. A ghost evaluation image A is an image in which the halftone image of FIG. 4A is used for the halftone image 33 of FIG. 3, and a ghost evaluation image B is an image in which the halftone image of FIG. 4B is used for the halftone image 33 of FIG. 3.

For the evaluation of ghost, after the ghost evaluation images A and B, a solid white image, and a solid black image were each printed out, the level of the ghost of each of the ghost evaluation images A and B was evaluated by visual inspection based on the following criteria.

### Ghost Evaluation Criteria

Rank 1: No ghosts are generated in the ghost evaluation images A and B.
Rank 2: A ghost is slightly observed only in the ghost evaluation image A.
Rank 3: Ghosts are slightly observed both in the ghost evaluation images A and B.
Rank 4: Ghosts are observed both in the ghost evaluation images A and B.
Rank 5: Ghosts are clearly observed both in the ghost evaluation images A and B.

TABLE 2

Ghost Evaluation

| | | Immediately After |
|---|---|---|
| Example | Initial Stage | Sheet Passing Test |
| Example 1 | 1 | 1 |
| Example 2 | 1 | 1 |
| Example 3 | 1 | 1 |
| Example 4 | 1 | 1 |
| Example 5 | 1 | 1 |
| Example 6 | 1 | 2 |
| Example 7 | 1 | 2 |
| Example 8 | 1 | 2 |
| Example 9 | 1 | 2 |
| Example 10 | 1 | 1 |
| Example 11 | 1 | 1 |
| Example 12 | 1 | 1 |
| Example 13 | 1 | 1 |
| Example 14 | 1 | 2 |
| Example 15 | 1 | 2 |
| Example 16 | 2 | 3 |
| Example 17 | 1 | 2 |
| Example 18 | 1 | 1 |
| Example 19 | 2 | 3 |
| Example 20 | 1 | 2 |
| Example 21 | 1 | 1 |
| Example 22 | 2 | 3 |
| Example 23 | 2 | 2 |
| Example 24 | 1 | 1 |
| Example 25 | 2 | 3 |
| Example 26 | 2 | 2 |
| Example 27 | 1 | 1 |
| Comparative Example 1 | 4 | 5 |
| Comparative Example 2 | 4 | 5 |
| Comparative Example 3 | 3 | 4 |
| Comparative Example 4 | 3 | 4 |
| Comparative Example 5 | 3 | 3 |
| Comparative Example 6 | 4 | 5 |
| Comparative Example 7 | 4 | 5 |
| Comparative Example 8 | 4 | 5 |
| Comparative Example 9 | 4 | 5 |
| Comparative Example 10 | 4 | 5 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-096013, filed Apr. 30, 2013, which is hereby incorporated by reference herein in its entirety.

1. An electrophotographic photosensitive member comprising:
a support;
an undercoat layer formed on the support; and
a photosensitive layer formed on the undercoat layer,
wherein the undercoat layer comprises:
metal oxide particles, and
a compound represented by the following formula (1), 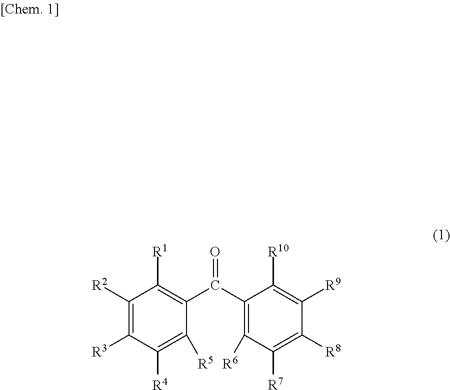
wherein in the formula (1),
R¹ to R¹⁰ each independently represents a hydrogen atom, a halogen atom, a hydroxy group, a carboxyl group, an unsubstituted or substituted alkyl group, or an unsubstituted or substituted alkoxy group,
R⁵ and R⁶ together may form a single bond, and
at least one of R¹ to R¹⁰ represents a carboxyl group.

2. The electrophotographic photosensitive member according to claim 1, wherein the content of the compound represented by the formula (1) in the undercoat layer is in a range of 0.05 to 4 percent by mass with respect to the metal oxide particles.

3. The electrophotographic photosensitive member according to claim 1, wherein in the formula (1), R¹ to R¹⁰ each independently represent a hydrogen atom, a hydroxy group, or a carboxyl group.

4. The electrophotographic photosensitive member according to claim 1, wherein in the formula (1), R¹ to R⁴ and R⁷ to R¹⁰ each independently represents a hydrogen atom, a hydroxy group, or a carboxyl group, R⁵ and R⁶ together form a single bond, and at least one of R¹ to R⁴ and R⁷ to R¹⁰ represents a carboxyl group.

5. The electrophotographic photosensitive member according to claim 3, wherein the compound represented by the formula (1) is a compound represented by the following formula (2): 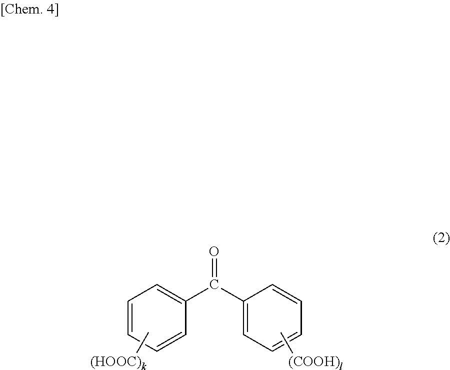
wherein in the formula (2), k and l each represent an integer of 0 or more, and the total of k and l is 1 to 3.

6. The electrophotographic photosensitive member according to claim 4, wherein the compound represented by the formula (1) is a compound represented by the following formula (3): 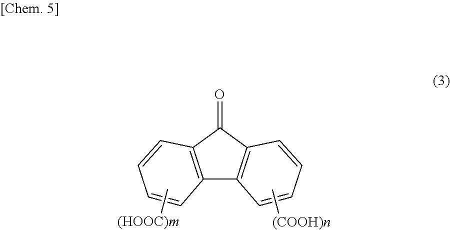
wherein in the formula (3), m and n each represent an integer of 0 or more, and the total of m and n is 1 or 2.

7. The electrophotographic photosensitive member according to claim 1, wherein the metal oxide particles are particles comprising at least one type selected from the group consisting of titanium oxide and zinc oxide.

8. A process cartridge which integrally supports the electrophotographic photosensitive member according to claim 1 and at least one selected from the group consisting of a charging unit, a developing unit, a transferring unit, and a cleaning unit and which is detachable to a main body of an electrophotographic apparatus.

9. An electrophotographic apparatus comprising:
the electrophotographic photosensitive member according to claim 1; and
a charging unit, an exposure unit, a developing unit, and a transferring unit.

10. A method for manufacturing an electrophotographic photosensitive member which comprises an undercoat layer formed on a support and a photosensitive layer formed on the undercoat layer, the method comprising:
forming a coating film from an undercoat-layer coating solution comprising metal oxide particles and a compound represented by the following formula (1); and
heating and drying the coating film to form the undercoat layer, 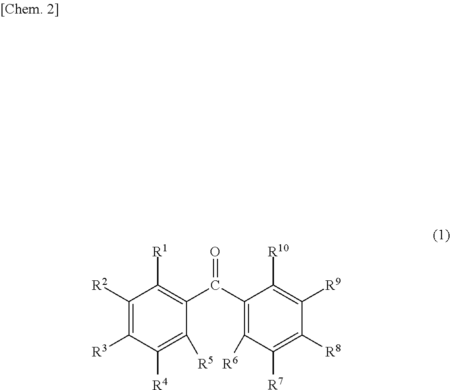
wherein in the formula (1), R¹ to R¹⁰ each independently represents a hydrogen atom, a halogen atom, a hydroxy group, a carboxyl group, an unsubstituted or substituted alkyl group, or an unsubstituted or substituted alkoxy group,
R⁵ and R⁶ together may form a single bond, and
at least one of R¹ to R¹⁰ represents a carboxyl group.

11. The method for manufacturing an electrophotographic photosensitive member according to claim 10, wherein the content of the compound represented by the formula (1) in the undercoat-layer coating solution is in a range of 0.05 to 4 percent by mass with respect to the metal oxide particles.

12. The method for manufacturing an electrophotographic photosensitive member according to claim 10, wherein in the formula (1), R¹ to R¹⁰ each independently represent a hydrogen atom, a hydroxy group, or a carboxyl group.

13. The method for manufacturing an electrophotographic photosensitive member according to claim 10, wherein in the formula (1), R¹ to R⁴ and R⁷ to R¹⁰ each independently represents a hydrogen atom, a hydroxy group, or a carboxyl group, R⁵ and R⁶ together form a single bond, and at least one of R¹ to R⁴ and R⁷ to R¹⁰ represents a carboxyl group.

14. The method for manufacturing an electrophotographic photosensitive member according to claim 12, wherein the compound represented by the formula (1) is a compound represented by the following formula (2): 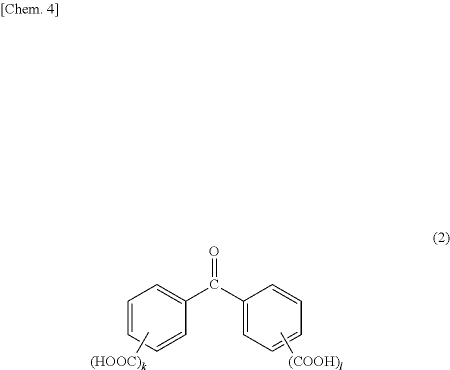
wherein in the formula (2), k and l each represent an integer of 0 or more, and the total of k and l is 1 to 3.

15. The method for manufacturing an electrophotographic photosensitive member according to claim 13, wherein the compound represented by the formula (1) is a compound represented by the following formula (3): 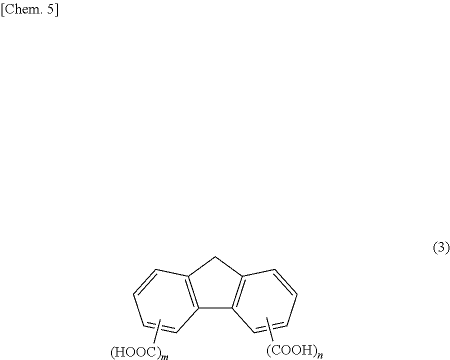
wherein in the formula (3), m and n each represent an integer of 0 or more, and the total of m and n is 1 or 2.
